(19) United States
(12) Patent Application Publication
(10) Pub. No.: US 2011/0241897 A1
(43) Pub. Date: Oct. 6, 2011

(54) SYSTEM AND METHOD FOR REAL TIME DATA TRANSMISSION DURING WELL COMPLETIONS

(75) Inventors: Jack V. Haynes, Houston, TX (US); Stephen T. Edwards, Hockley, TX (US); Catherine Hyde-Barber, Richmond, TX (US)

(73) Assignee: BP CORPORATION NORTH AMERICA INC., Houston, TX (US)

(21) Appl. No.: 13/078,186

(22) Filed: Apr. 1, 2011

Related U.S. Application Data
(60) Provisional application No. 61/320,173, filed on Apr. 1, 2010.

(51) Int. Cl. E21B 47/16; E21B 43/04; G01V 3/00

(52) U.S. Cl. 340/854.5; 367/82; 166/51

(57) ABSTRACT

Presently, existing completion tools have not been designed to couple with wired drill pipe. As such, present completions operations and tools have not been able to take advantage of the expanded bandwidth in wire drill pipe. Instead of designing new completions tools with wired pipe connections, the disclosed system and methods propose use of a short-hop or wireless system to transmit data from a completions tool to an upper receiver module coupled to the wired drill pipe. Various measurements from the region around the completions tool may be transmitted from one or more lower wireless modules to the upper wireless module and then transmitted through the wired drill pipe to the surface. Likewise, signals may be transmitted from the surface through the wired drill pipe to the upper module and then to the lower wireless module.

### CROSS-REFERENCE TO RELATED APPLICATIONS

This application claims benefit of U.S. provisional application Ser. No. 61/320,173 filed Apr. 1, 2010, which is hereby incorporated herein by reference in its entirety

### STATEMENT REGARDING FEDERALLY SPONSORED RESEARCH OR DEVELOPMENT

Not applicable.

### BACKGROUND

1. Field of the Invention

This invention relates generally to the field of drilling and completions. More specifically, the invention relates to a system and methods of transmitting data during well completions.

2. Background of the Invention

Once a well is drilled, and it has been verified that commercially viable quantities of hydrocarbons (i.e. oil or natural gas) are present for extraction, the well must be “completed” to allow for the flow of hydrocarbons out of the formation and up to the surface. This process may include strengthening the well hole with casing, evaluating the pressure and temperature of the formation, and then installing the proper equipment to ensure an efficient flow of hydrocarbons out of the well. Completing a well generally includes a number of steps such as without limitation, installing the well casing, completing the well, installing well liners, perforating the well, installing the wellhead, and installing lifting equipment or treating the formation should that be required.

In completing wells having production or injection zones which lie adjacent incompetent subterranean formations (i.e. formations formed of an unconsolidated matrix such as loose sandstone or the like) or which lie adjacent formations which have been hydraulically-fractured and propped, serious consideration must be given to the problems of sand control. These problems arise when large volumes of sand and/or other particulate material (e.g. backflow of proppants from a hydraulically-fractured formation) dislodge from the formation and become entrained in the produced formation fluids. These particulate materials are highly detrimental to the operation of the well and routinely cause erosion, plugging, etc. of the well equipment which, in turn, leads to high maintenance costs and considerable downtime of the well.

One of the best known techniques for alleviating sand production involve “gravel packing” the borehole adjacent the production formation. Basically, gravel packing includes the steps of placing a fluid-permeable liner (screen, slotted pipe, etc.) within the borehole (cased or open) adjacent the production interval and then filling the annulus formed between the borehole wall and the liner with gravel or the like. When properly positioned in the annulus, the gravel supports the walls, prevents caving of loose material against the liner, and serves to restrain particulate material from the formation, e.g. sand, from flowing into the borehole with the produced fluids. Gravel packing is just one of many completions operations that may be needed in completing a well for production.

Presently, few technologies are available that allow wellbore data from a completions tool to be transmitted to the surface in real time during a completions operations such as gravel packing. There are numerous downhole measurements in the proximity of completion tool components that would be useful for optimizing the completions installation process if they were available in real-time. These include internal and external pressure and temperature measurements on the drillpipe, washpipe and other down-hole completion components, density, strain, flow rate, position and mechanical loadings.

Consequently, there is a need for systems and methods for transmitting data during completions in real time.

### BRIEF SUMMARY

Methods and systems for transmitting real-time data during completions are disclosed herein. The described methods and systems utilize wired drill pipe and short hop technology to enable real-time transmission of downhole data. Further aspects and advantages of the methods and systems are described in more detail below.

Wired drillpipe is a commercially available technology that is now being used to send up data from downhole tools during the drilling process. Wired drill pipe is not being presently used to transmit downhole data during completions installation. However, there are numerous downhole measurements during the completions process that would be useful for optimizing the completions installation process if they were available in real-time. In short, the presence of wired drill pipe, which can transmit large volumes of data to surface instantaneously without the need for pumping fluid/mud pulse or other telemetry techniques, is potentially a big enabler for sending up these actionable downhole measurements during the completion installation.

In an embodiment, the method comprises inserting a completions tool coupled to a wired drill pipe into a well to complete the well. The completions tool comprises a short-hop wireless communications system having an upper wireless module and a lower wireless module. The upper wireless module is coupled to the wired drill pipe and converts wireless signals for transmittal through the wired drill pipe. The upper wireless module and the lower wireless module are in wireless communication with one another. The method further comprises initiating a completions operation. In addition, the method comprises measuring one or more well properties during the completions operation using one or more sensors disposed on the completions tool. The method also comprises transmitting the one or more well properties in real-time via the short-hop wireless communications system through the wired drill pipe to the surface.

In an embodiment, a system for transmitting data during well completion comprises a completions tool having an upper wireless module and a lower wireless module. The system also comprises a wired drill pipe coupled to the upper wireless module. The upper wireless module is configured to receive and transmit wireless signals to the lower wireless module and to convert wireless signals to electrical signals for transmission through the wired drill pipe.

In another embodiment, a system for transmitting data during well completion comprises an upper wireless acoustic module. The system further comprise a completions tool disposed below the upper wireless module. In addition, the system comprise a lower wireless acoustic module disposed below the gravel pack service tool. Moreover, the system comprises a wash pipe coupled to the lower wireless acoustic module. The wash pipe comprises one or more sensors for measuring one or more downhole properties. The system also comprises a wired drill pipe coupled to the upper wireless acoustic module. The upper wireless acoustic module is configured to receive and transmit acoustic signals to the lower wireless acoustic module and to convert acoustic signals to electrical signals for transmission through the wired drill pipe.

Presently, existing completion tools have not been designed to couple with wired drill pipe. As such, present completions operations and tools have not been able to take advantage of the expanded bandwidth in wired drill pipe. Instead of designing new complex completions tools with wired pipe connections, the disclosed system and methods propose use of a short-hop or wireless system to transmit data from a completions tool to an upper wireless module coupled to the wired drill pipe. Various measurements from the well regions and formation surrounding the completions tool may be transmitted from one or more lower wireless modules to the upper wireless module and then transmitted through the wired drill pipe to the surface. Likewise, signals may be transmitted from the surface through the wired drill pipe to the upper module and then to the lower module. With the use of wireless short-hop technology, cost savings may be achieved by modifying existing completions tools to take advantage of the wired drill pipe.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of a system for data transmission during well completions;

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections. The terms “up” and “down”, “upper” and “lower”, “upwardly” and “downwardly”, “upstream” and “downstream”, “above” and “below”, and other like terms indicating relative positions above or below a given point or element are used in this description to more clearly describe some embodiments of the invention. However, when applied to equipment and methods for use in wells that are deviated or horizontal, such terms may refer to a left to right, right to left, or other relationship as appropriate.

As used herein, the term “completions,” “well completions,” may all refer to the process of making a well ready for production. This process principally involves preparing the bottom of the hole to the required specifications, running in the production tubing and its associated down hole tools as well as perforating and stimulating as required. More particularly, as is well known in the art, “completions” is a separate and distinct process from “drilling.”

As used herein, the term “gravel pack,” “gravel pack operations,” or “gravel packing” generally refers to any completion operations of inserting or injecting gravel or its equivalents (e.g. sand or other proppants) into the bottom of the well to prevent the passage of particulate matter into the wellbore.

As used herein, the term “real time” can mean instantaneous or nearly instantaneous streaming or transmission of data or information.

As used herein, “wired drill pipe” refers to a drill string, tubing or tubular having a hard-wired data transmission network as opposed to wireless, electromagnetic, or mud pulse transmission networks. Wired drill pipe uses physical wires built into every component of the drill string, which carry electrical signals directly to the surface. These systems allow data transmission rates orders of magnitude greater than anything possible with mud pulse or electromagnetic telemetry, both from the downhole tool to the surface, and from the surface to the downhole tool. Details of wired drill pipe may be found in U.S. Pat. No. 6,670,880, incorporated herein by reference in its entirety for all purposes.

As used herein, “wash pipe” refers to a tubular device that is usually provided within the liner extending from a crossover tool (not shown) to near the bottom of the liner. Returning carrier fluid, after passing through the liner, enters the wash pipe at the lower end of the wash pipe, and travels up the wash pipe to the crossover tool. The crossover tool directs this returning carrier fluid to the annulus outside of the drill pipe, above the packers, and up to the surface.

As used herein, “wired wash pipe” refers to a wash pipe having an embedded wired network or physical wires/cables within the wash pipe for the transmittal of electrical signals.

### DETAILED DESCRIPTION OF THE PREFERRED EMBODIMENTS

Embodiments of the methods and system will be described in connection with the exploration and production of gaseous or liquid hydrocarbons either onshore or offshore. Additionally, embodiments of the systems and methods will be described with respect to vertical wells, however, it is contemplated that the disclosed methods and systems may also be used in horizontal wells.

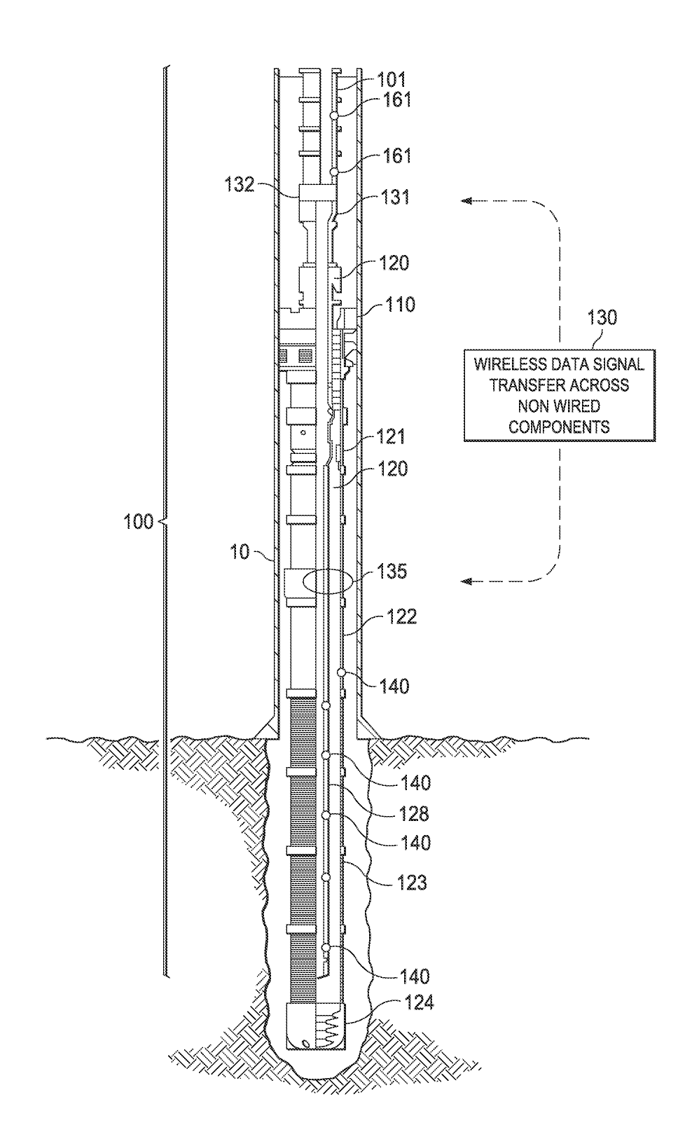

FIG. 1 illustrates of an embodiment of a system 100 for data transmission during well completions. As an example, FIG. 1 depicts a typical sand face completion bottom-hole assembly 110 in the installation mode. However, it is envisioned that any known completion tools may be used in conjunction with the system and disclosed methods. Furthermore, the disclosed methods may be used with any completions methods including without limitation, gravel pack operations, a frac pack operation, a high rate water pack, perforation operation, a sand exclusion operation, a sand consolidation operation, or combinations thereof.

In an embodiment, the completions packer 110 such as a gravel pack packer and all sub components (e.g. port closure assembly 121, blank pipe 122, screen or liner 123, wash-down shoe 124, wash pipe 128 etc.) may be deployed in the wellbore coupled to a wired drill pipe 101 and a completions tool 120 such as a gravel pack service tool. Gravel pack service tools are well known in the art. Examples of such tools and their respective components are described, for example, in U.S. Pat. Nos. 3,987,854 and 4,940,093, incorporated herein in their entireties for all purposes.

In an embodiment, measuring devices 140 which record the downhole data (e.g. bottom-hole pressure, temperature, etc) may be integrated and distributed at any position along the assembly 120. For example, measuring devices 140 may be located at wash pipe 128, below the packer 110, and/or into the pipe just above the packer 110. In the exemplary embodiment depicted in FIG. 1, the location of these measuring devices 140 are denoted by the dots () and indicate where various down-hole measurements could be extracted. Because completion strategies vary on a case by case basis, the type of completion strategy will dictate the placement of these measuring devices 140.

Examples of measuring devices 140 that may be used in the connection with the disclosed methods and system include without limitation sensors, sampling devices, temperature sensors, pressure sensors, flow-control devices, flow rate measurement devices, oil/water/gas ratio measurement devices, scale detectors, actuators, locks, release mechanisms, equipment sensors (e.g., vibration sensors), sand detection sensors, water detection sensors, data recorders, viscosity sensors, density sensors, bubble point sensors, pH meters, multiphase flow meters, acoustic sand detectors, solid detectors, composition sensors, resistivity array devices and sensors, acoustic devices and sensors, other telemetry devices, near infrared sensors, gamma ray detectors, chemical detectors, downhole memory units, downhole controllers, perforating devices, shape charges, firing heads, locators, and other downhole devices.

Embodiments of the overall system 100 utilize “short hop” wireless communications system 130 for wireless data transmission or communication of down-hole measurements (e.g. pressure, pressure differential, temperature, temperature differential, density, strain, volumetric flow rate, position, mechanical loading and mechanical integrity) across the completion bottom-hole assembly (BHA) or tool 120. As used herein, the term “short-hop” or “short-hop technology” refers to any wireless methods or devices for transmitting signals over a short distance. Short hop technology also enables signals generated at the surface that are sent via wired drill-pipe to be wirelessly transferred across the completion bottom-hole assembly (BHA) 120, enabling remote adjustment of certain down-hole completion or service string components. In general, the short hop wireless communication system 130 involves an upper wireless module 131, and a lower wireless module 135 that may be disposed integrally to the completion bottom hole assembly (BHA) 110 (e.g. screen assemblies, blank pipe, locator assemblies, bull plugs, etc.) and deployment string (e.g. drill-pipe and wash pipe 128). The number, placement and configuration of these modules can vary depending on the completion strategy selected for a particular application.

Although it is envisioned that the short-hop system 130 (e.g. wireless modules 131, 135) may use any type of wireless technology such as electromagnetic signals, preferably, acoustic technology is used as the wireless transmission technique. Acoustic wireless technology uses encoded acoustic waves to transmit signals across short distances ranging for example, from about 1 foot to about 1,000 feet, alternatively at least about 500 feet, alternatively at least about 200 feet. Such signals may have frequencies which range for example, from about 1 Hz to about 100 MHz. Acoustic transmitters and receivers convert an electrical signal into an elastic wave which has an extensional motion and vice versa. An example of a suitable acoustic wireless module may include without limitation, piezoelectric transducers.

The lower wireless module 135 can serve the function of measuring and recording multiple down-hole measurements, capturing distributed down-hole measurements made along a washpipe 128 or completion components below the packer 110 and instantaneously, or near instantaneously, streaming all measurements to the upper wireless module 131.

Because the upper wireless module 131 is coupled to the wired drill-pipe 101 (e.g. via lower wired module 132, or directly coupled), it can serve the function of measuring and recording multiple down-hole measurements above the packer 120 as well as capturing the data transferred from the lower wireless module 135. In addition, because the upper wireless module 131 is directly coupled to the wired drill pipe 101, all data would then be rapidly transmitted thru the wired drill-pipe to the surface for immediate conversion and transfer to multiple satellite locations. Upper wireless module 131 is preferably adapted or configured to couple to existing wired drill pipe designs. Furthermore, upper wireless module 131 converts the wireless signal to an electrical signal suitable for transmission through the wired drill pipe 101. In embodiments utilizing acoustic wireless signals, upper wireless module 131 would receive acoustic signals from lower wireless module 135 and convert the acoustic signals into a suitable electric signal for transmission up the wired pipe 101. Additionally, upper wireless module 131 may also receive electric signals from wired pipe 101 and convert them to wireless acoustic signals for wireless transmission to lower wireless module 135. In other words, upper wireless module 131 and lower wireless module can be configured as “two way” wireless modules. Lower wireless module 135 may be coupled to wash pipe 128 or coupled to a completions tool 120 such as a gravel pack service tool. That is, in some embodiments, a wash pipe 128 is not present and the lower wireless module 135 is coupled only to the completions tool 120.

Embodiments of the system also can incorporate a lower wired pipe conversion module 132. Lower wired pipe conversion module 132 is in communication with upper wireless module 131 and wired pipe 101. The upper wireless module 131 presents electrical signals to the lower wired pipe conversion module 132 that accepts the signal on behalf of the wired pipe network 101. More particularly, lower wired pipe conversion module 132 is configured to convert the electrical signals from upper wireless module 131 into a digital format suitable for transmittal along the wired pipe. The lower wired pipe module also converts signals from the surface and presents electrical signals from the wired pipe network to the upper wireless module 131 for conversion to wireless signals and transmittal to the lower wireless module 135. Of course, the same may be said for electromagnetic versions of the short-hop wireless communications system 130.

In an embodiment where adjustable down-hole completion or service string components in the tool 120, the wireless modules may be configured for two way functionality or communications. In this instance, a signal, or signals, sent from a surface source down the wired drill-pipe 101 can be collected and converted as required at the upper wireless module 131 and then wirelessly transmitted either directly to the down-hole adjustable components or directly to one or more lower wireless modules for wireless transmission directly to the down-hole adjustable components.

In an embodiment, wash pipe 128 is a wired washpipe with integral measuring devices 140 that are used to record certain downhole measurements (e.g. pressure and temperature), additional components with integral sensor assemblies would be further integrated to capture additional down-hole measurements extending beyond the capabilities of the memory gauges. All of the gauges and sensor assemblies would be directly linked to the wired wash pipe 128 for data transmission to the lower wireless module 135. Data would then be transmitted via upper wireless module 131 and wired pipe 101 to the surface.

In another embodiment, wash pipe 128 is a wired wash pipe where distributed measuring modules 140 integral to the wired wash pipe 128 may be used to record multiple down-hole measurements. In this embodiment, all of the distributed measuring modules 140 would be directly linked to the wired wash pipe 128 for data transmission to the lower wireless module 135. The features incorporated in the lower wireless modules 135 would then be utilized for rapid data delivery to the surface for immediate transmission to multiple satellite locations. Data would then be transmitted via upper wireless module 131 and wired pipe 101 to the surface.

In embodiments with conventional wash pipe, measuring devices or integral sensors 140 equipped with wireless telemetry capabilities can be distributed along the wash pipe to record multiple down-hole measurements. In this instance all of the measurements captured in the measuring devices would be streamed to the lower wireless module 135 for transfer to the upper wireless module 131. The devices 140 are wirelessly coupled to lower wireless module 135. In such embodiments, lower wireless module 135 would have wireless receiving and transmitting capabilities. Because the upper wireless module 131 is directly coupled to the wired drill pipe, all data may be rapidly transmitted thru the wired drill-pipe to the surface for immediate conversion and transfer to multiple satellite locations.

Although embodiments of the disclosed method and systems have been described with respect to transmittal of real-time date during a completions operation, the same method and systems may be used after completion of a well to monitor and transmit data during the life of the well. More particularly, wired production tubing (as opposed to drilling wired pipe) may be inserted into the well. The wired production tubing may be coupled to a downhole tool with wireless modules and any sensors known to those of skill in the art and also described herein. The wireless modules may be like this described for the short-hop system 100. The downhole tool may remain at the bottom of the well during production and monitor various parameters for the life of the well. The parameters can then be transmitted in real time back to the surface. In this embodiment, the wireless modules could be or would be attached to well equipment that remains in the well e.g. the sand control screens, a tubular stinger, a permanent wash pipe, rather than to the wash pipe which is removed from the well at the end of the installation operation

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of transmitting data during well completions comprising:
a) inserting a completions tool coupled to a wired drill pipe into a well to complete the well, wherein the completions tool comprises a short-hop wireless communications system having an upper wireless module and a lower wireless module, the upper wireless module is coupled to the wired drill pipe and converts wireless signals for transmittal through the wired drill pipe, and wherein the upper wireless module and the lower wireless module are in wireless communication with one another;
b) initiating a completions operation;
c) measuring one or more well properties during the completions operation using one or more sensors disposed on the completions tool; and
d) transmitting the one or more well properties in real-time via the short-hop wireless communications system from the completions tool to the wired drill pipe and through the wired drill pipe to the surface.

2. The method of claim 1 wherein (d) comprises wirelessly transmitting the one or more well properties from the completions tool across a distance of at least 200 feet to the wired drill pipe.

3. The method of claim 1 wherein the one or more well properties comprises temperature, pressure, strain, stress, load, composition, pH, viscosity, radiation, concentration, or combinations thereof.

4. The method of claim 1 wherein the short-hop wireless communications systems is an electromagnetic wireless system, an acoustic wireless system, or combinations thereof.

5. The method of claim 1 wherein the one or more sensors are coupled to the lower wireless module.

6. The method of claim 1 the short-hop wireless communications system comprises a plurality of lower wireless modules.

7. The method of claim 5 wherein the lower wireless modules comprises the one or more sensors.

8. The method of claim 1 wherein the completions tool is a gravel pack tool.

9. The method of claim 1 wherein the completions operation is a gravel pack operation, a frac pack operation, a high rate water pack, perforation operation, a sand exclusion operation, a sand consolidation operation, or combinations thereof.

10. The method of claim 1 further comprising transmitting the one or more well properties from the completions tool to the surface.

11. A system for transmitting data during well completion comprising:
a completions tool having an upper wireless module and a lower wireless module;
a wired drill pipe coupled to the upper wireless module of the completions tool, wherein the upper wireless module is configured to receive and transmit wireless signals to the lower wireless module and to convert wireless signals to electrical signals for transmission through the wired drill pipe.

12. The system of claim 11 wherein the upper wireless module and the lower wireless module are two-way acoustic wireless modules.

13. The system of claim 11 wherein the wired drill pipe comprises a lower wired pipe conversion module, wherein the wired pipe conversion module is configured to convert electrical signals from the upper wireless module for transmission through the wired drill pipe.

14. The system of claim 10 wherein the completions tool comprises a plurality of wireless modules.

15. The system of claim 10 wherein the completions tool comprises a plurality of upper wireless modules.

16. The system of claim 10 wherein the upper wireless module converts electrical signals to wireless signals for transmittal to the lower wireless module.

17. The system of claim 10 wherein the completions tool is a gravel pack service tool.

18. The system of claim 10 wherein the completions tool comprises a wired wash pipe coupled to the lower wireless module.

19. A system for transmitting data during well completion comprising:
an upper wireless acoustic module;
a completions tool disposed below the upper wireless module;
a lower wireless acoustic module disposed below the gravel pack service tool;
a wash pipe coupled to the lower wireless acoustic module, wherein the wash pipe comprises one or more sensors for measuring one or more downhole properties;
a wired drill pipe coupled to the upper wireless acoustic module, wherein the upper wireless acoustic module is configured to receive and transmit acoustic signals to the lower wireless acoustic module and to convert acoustic signals to electrical signals for transmission through the wired drill pipe.

20. The system of claim 19 wherein the completions tool is a gravel pack service tool.
